(19) United States
(12) Patent Application Publication
(10) Pub. No.: US 2009/0222372 A1
(43) Pub. Date: Sep. 3, 2009

(54) Method of Creating and Trading Derivative Investment Products Based on a Statistical Property Reflecting the Volatility of an Underlying Asset

(76) Inventor: John Hiatt, JR., Woodridge, IL (US)

Correspondence Address: BRINKS HOFER GILSON & LIONE, P.O. BOX 10395, CHICAGO, IL, 60610, US

(21) Appl. No.: 12/394,798

(22) Filed: Feb. 27, 2009

Related U.S. Application Data
(63) Continuation of application No. 11/601,284, filed on Nov. 17, 2006, now abandoned.

(51) Int. Cl. G06Q 40/00

(52) U.S. Cl. 705/37

(57) ABSTRACT

A method of creating and trading derivative contracts based on a statistical property reflecting a volatility of an underlying asset is disclosed. Typically, an underlying asset is chosen to be a base of a volatility derivative and a processor calculates a value of the statistical property reflecting an average volatility of price returns of the underlying asset over a predefined period. A trading facility display device coupled to a trading platform then displays the volatility derivative based on the value of the statistical property reflecting the volatility of the underlying asset and the trading facility transmits volatility derivative quotes from liquidity providers over at least one dissemination network.

### RELATED APPLICATIONS

The present application is a continuation of U.S. patent application Ser. No. 11/601,284 (still pending), filed Nov. 17, 2006, the entirety of which is hereby incorporated by reference.

### TECHNICAL FIELD

The present invention relates to derivative investment markets. More specifically, this invention relates to aspects of actively disseminating and trading derivatives.

### BACKGROUND

A derivative is a financial security whose value is derived in part from a value or characteristic of another security, known as an underlying asset. Two exemplary, well known derivatives are options and futures.

An option is a contract giving a holder of the option a right, but not an obligation, to buy or sell an underlying asset at a specific price on or before a certain date. Generally, a party who purchases an option is referred to as the holder of the option and a party who sells an option is referred to as the writer of the option.

There are generally two types of options: call options and put options. A holder of a call option receives a right to purchase an underlying asset at a specific price, known as the “strike price,” such that if the holder exercises the call option, the writer is obligated to deliver the underlying asset to the holder at the strike price. Alternatively, the holder of a put option receives a right to sell an underlying asset at a specific price, referred to as the strike price, such that if the holder exercises the put option, the writer is obligated to purchase the underlying asset at the agreed upon strike price. Thus, the settlement process for an option involves the transfer of funds from the purchaser of the underlying asset to the seller, and the transfer of the underlying asset from the seller of the underlying asset to the purchaser. This type of settlement may be referred to as “in kind” settlement. However, an underlying asset of an option does not need to be tangible, transferable property.

Options may also be based on more abstract market indicators, such as stock indices, interest rates, futures contracts and other derivatives. In these cases, in kind settlement may not be desired, or in kind settlement may not be possible because delivering the underlying asset is not possible. Therefore, cash settlement is employed. Using cash settlement, a holder of an index call option receives the right to “purchase” not the index itself, but rather a cash amount equal to the value of the index multiplied by a multiplier such as $100. Thus, if a holder of an index call option elects to exercise the option, the writer of the option is obligated to pay the holder the difference between the current value of the index and the strike price multiplied by the multiplier. However, the holder of the index will only realize a profit if the current value of the index is greater than the strike price. If the current value of the index is less than or equal to the strike price, the option is worthless due to the fact the holder would realize a loss.

Similar to options contracts, futures contracts may also be based on abstract market indicators. A future is a contract giving a buyer of the future a right to receive delivery of an underlying commodity or asset on a fixed date in the future. Accordingly, a seller of the future contract agrees to deliver the commodity or asset on the specified date for a given price. Typically, the seller will demand a premium over the prevailing market price at the time the contract is made in order to cover the cost of carrying the commodity or asset until the delivery date.

Although futures contracts generally confer an obligation to deliver an underlying asset on a specified delivery date, the actual underlying asset need not ever change hands. Instead, futures contracts may be settled in cash such that to settle a future, the difference between a market price and a contract price is paid by one investor to the other. Again, like options, cash settlement allows futures contracts to be created based on more abstract “assets” such as market indices. Rather than requiring the delivery of a market index (a concept that has no real meaning), or delivery of the individual components that make up the index, at a set price on a given date, index futures can be settled in cash. In this case, the difference between the contract price and the price of the underlying asset (i.e., current value of market index) is exchanged between the investors to settle the contract.

Derivatives such as options and futures may be traded over-the-counter, and/or on other trading facilities such as organized exchanges. In over-the-counter transactions the individual parties to a transaction are free to customize each transaction as they see fit. With trading facility traded derivatives, a clearing corporation stands between the holders and writers of derivatives. The clearing corporation matches buyers and sellers, and settles the trades. Thus, cash or the underlying assets are delivered, when necessary, to the clearing corporation and the clearing corporation disperses the assets as necessary as a consequence of the trades. Typically, such standard derivatives will be listed as different series expiring each month and representing a number of different incremental strike prices. The size of the increment in the strike price will be determined by the rules of the trading facility, and will typically be related to the value of the underlying asset.

While standard derivative contracts may be based on many different types of market indexes or statistical properties of underlying assets, current standard derivative contracts do not provide investors with sufficient tools to hedge against greater than expected or less than expected volatility in an underlying asset.

### BRIEF SUMMARY

In order to provide a mechanism for hedging against potential volatility of an underlying asset, a system and method for creating and trading a standard derivative contract based on a statistical property that reflects the volatility of an underlying asset is disclosed. In a first aspect, a method of creating derivatives based on the volatility of an underlying asset is disclosed. First, a processor calculates a dynamic value for a statistical property reflecting an average volatility of price returns of the underlying asset over a predefined period. A trading facility display device coupled to a trading platform then displays at least one quote for a volatility derivative, based on the calculated dynamic value, from a liquidity provider and the trading facility transmits at least one volatility derivative quote from the liquidity provider through a dissemination network to at least one market participant.

In a second aspect, a method of creating derivatives based on the volatility of an underlying asset is disclosed. First, an underlying asset is chosen to be a base of a volatility derivative. A value for a statistical property reflecting the volatility of the underlying asset is calculated based on an average, over a variance calculation period, of a square root of a summation of a squared deviation of a daily return of the underlying asset from a previous daily return of the underlying asset. Each squared deviation of the daily return of the underlying asset that corresponds to a market disruption event is removed. Finally, a trading facility display device coupled to a trading platform displays quotes for the volatility derivative from at least one liquidity provider.

In a third aspect, a system is described for creating and trading derivatives based on the volatility of an underlying asset. Typically, the system comprises a volatility property module coupled with a communications network, a dissemination module coupled with the volatility property module and the communications network, and a trading module coupled with the dissemination module and the communications network. Generally, the volatility property module calculates a realized volatility, cumulative realized volatility, and implied realized volatility of the underlying asset. The volatility property module passes the calculated values to the dissemination module, which transmits the calculated values relating to the volatility derivative to at least one market participant. The trading module receives buy or sell orders for the volatility derivative, executes the buy or sell orders, and passes the result of the buy or sell orders to the dissemination module to transmit the result of the buy or sell order to at least one market participant.

### BRIEF DESCRIPTION

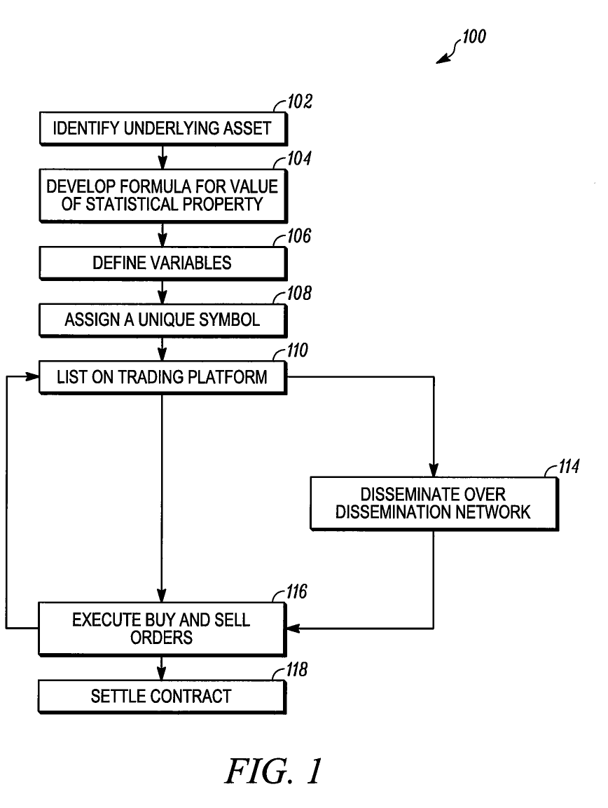

FIG. 1 is a flow chart of a method of creating and trading a derivative instrument reflecting the volatility of an underlying asset.

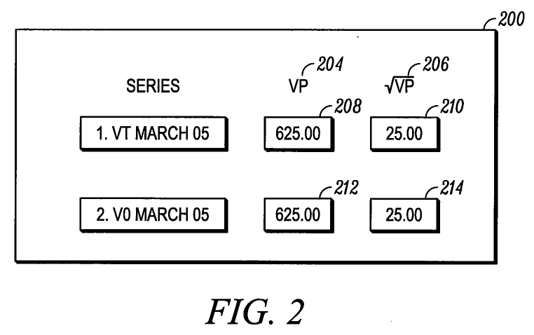

FIG. 2 is a diagram showing a listing of a volatility futures contract and a volatility options contract on a trading facility.

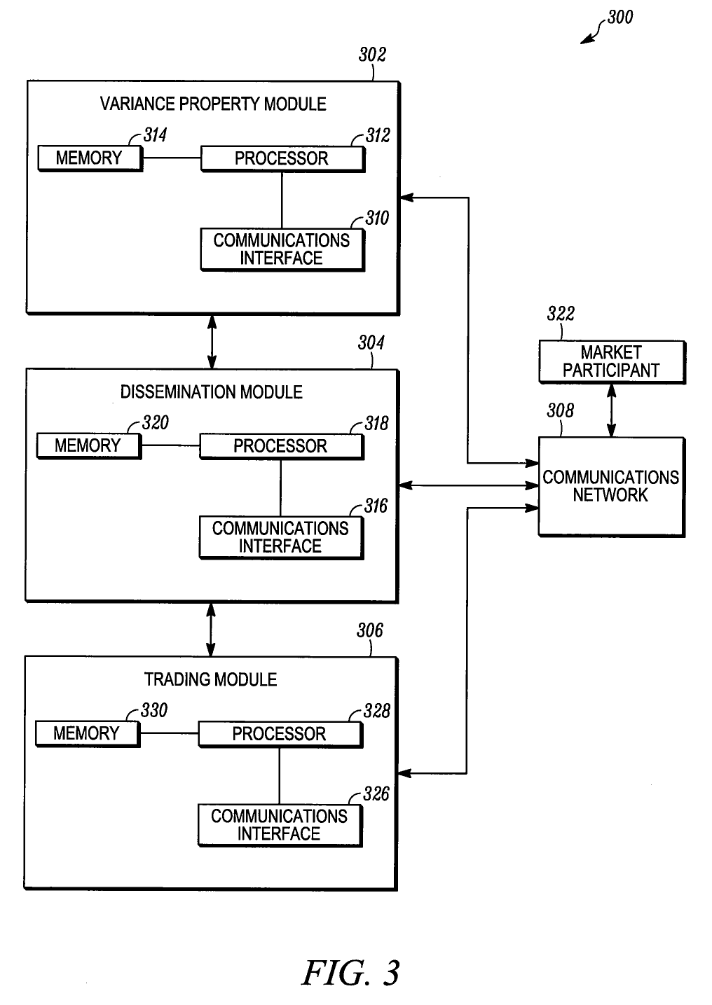

FIG. 3 is a block diagram of a system for creating and trading a derivative instrument reflecting the volatility of an underlying asset.

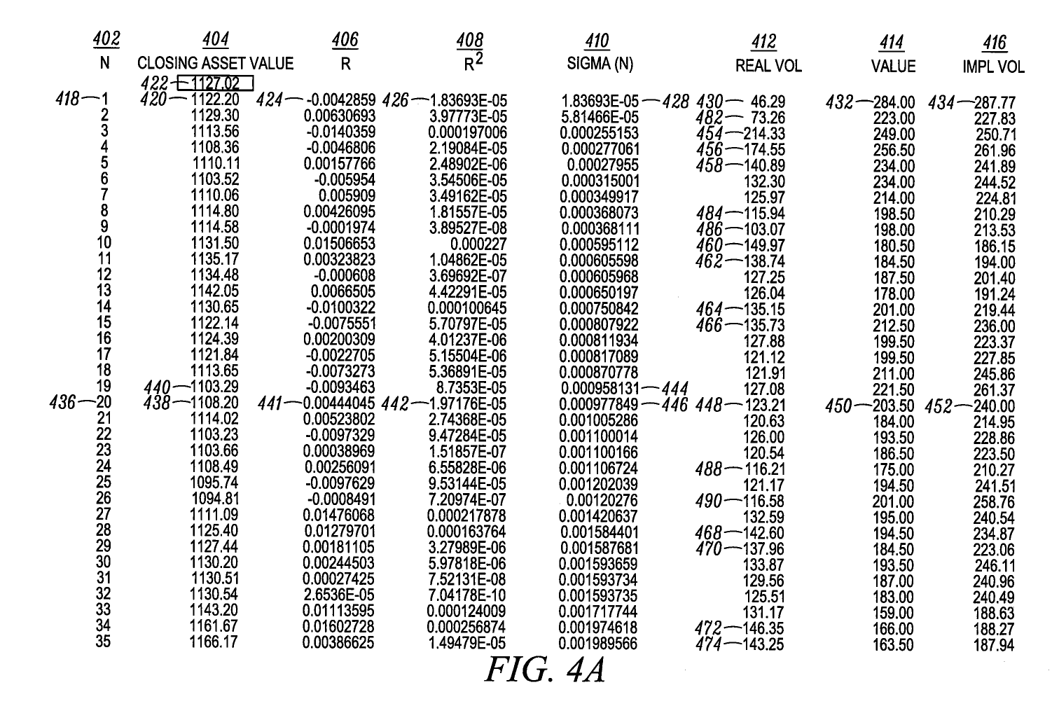

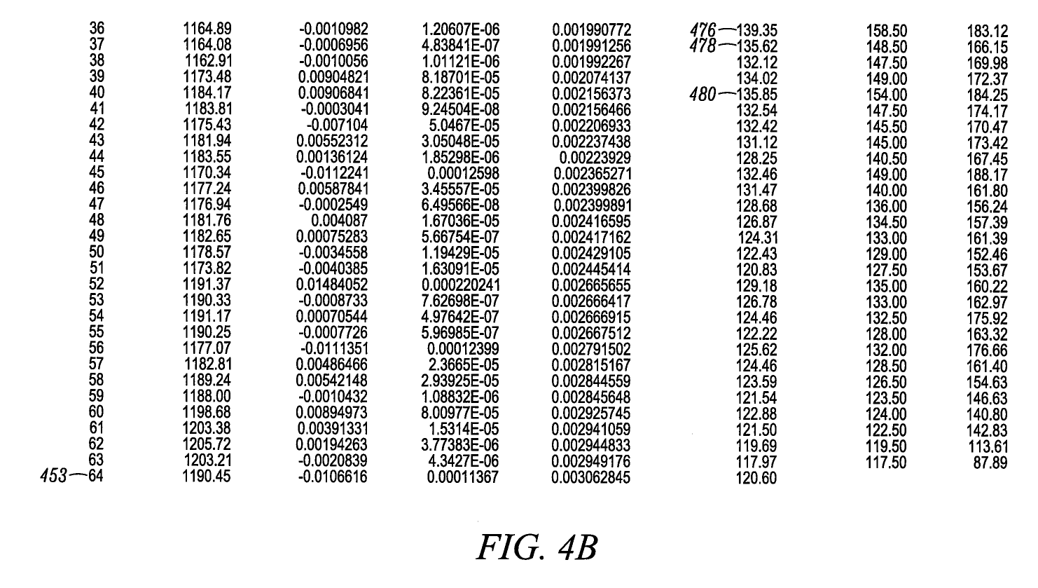

FIGS. 4A and 4B illustrate a table showing values for a derivative instrument reflecting the volatility of an underlying instrument over a volatility calculation period.

### DETAILED DESCRIPTION OF THE DRAWINGS

Volatility derivatives are financial instruments such as futures and option contracts that trade on trading facilities, such as exchanges, whose value is based on the volatility of the value of an underlying asset and not on the return of the underlying asset. Volatility can be calculated as the square root of a variance of an underlying asset, which is a measure of the statistical dispersion of the value of the underlying asset. Thus, variance indicates the movement in the value of an underlying asset from trading day to trading day. Typically, variance is computed as the average squared deviation of the value of an underlying asset from an expected value, represented by an average (mean) price return value.

Those skilled in the art will recognize that volatility derivatives having features similar to those described herein and statistical properties which reflect the volatility of an underlying asset, but which are given labels other than volatility derivatives, volatility futures, or volatility options will nonetheless fall within the scope of the present invention.

FIG. 1 is a flow chart of one embodiment of a method for creating and trading a derivative instrument, such as a volatility futures contract 100, reflecting the volatility of an underlying asset. A volatility futures contract is a financial instrument in which the realized volatility of an underlying asset is calculated at the end of each trading day over a predefined period, known as the volatility calculation period. Typically, the realized volatility of an underlying asset is calculated using a standardized equation, which is a function of a daily return of the underlying asset. The daily return of an underlying asset is typically the natural log of a final value of the underlying asset over an initial value of the underlying asset.

An investor is generally able to purchase a volatility futures contract before a volatility calculation period begins, or an investor may trade into or out of a volatility futures contract during the volatility calculation period. To facilitate the purchase and trading of volatility futures contracts, trading facilities such as exchanges like the CBOE Futures Exchange (CFE) will calculate and disseminate cumulative realized volatility and implied realized volatility values for a volatility futures contract. Cumulative realized volatility and implied realized volatility provide tools for investors to determine when to trade into and out of a volatility futures contract.

The method for creating and trading a volatility futures contract begins at step 102 by identifying an underlying asset or a set of underlying assets for the volatility futures contract. Typically, an underlying asset or set of assets is selected based on trading volume of a prospective underlying asset, the general level of interest of market participants in a prospective underlying asset, or for any other reason desired by a trading facility. The underlying assets for the volatility futures contract may be equity indexes or securities; fixed income indexes or securities; foreign currency exchange rates; interest rates; commodity indexes; commodity or structured products traded on a trading facility or in the over-the-counter (“OTC”) market; or any other type of underlying asset whose value may change from day to day.

Once the underlying asset or assets have been selected at 102, a formula is developed at 104 for generating a value for a statistical property reflecting the realized volatility of the underlying asset or assets over the defined volatility calculation period.

In one embodiment, realized volatility is calculated using a standard formula that uses an annualization factor and daily S&P 500 returns over the volatility calculation period, assuming a mean daily price return of zero. The annualization factor is normally a number that represents the number of days the underlying asset will trade in a year. Typically, the annualization factor is 252 to represent the number of trading days an underlying asset is traded in a year. However, for underlying assets that trade in international trading facilities or specialized trading facilities, the annualization factor may be a value other than 252.

Realized volatility may be calculated according to the formula:

$$Realized Volatility = \sqrt{AF * {\sum }_{i = 1}^{{N}_{a} - 1} \frac{{R}_{i}^{2}}{{N}_{e} - 1} ,}$$

$$wherein \text{:}$$

$${R}_{i} = ln \frac{{P}_{i + 1}}{{P}_{i}} ,$$

Pᵢ is an initial value of the underlying asset used to calculate a daily return, Pᵢ₊₁ is a final value of the underlying asset used to calculate the daily return, Nₑ is a number of expected underlying asset values needed to calculate daily returns during the volatility calculation period, Nₐ is an actual number of underlying asset values used to calculate daily returns during the volatility calculation period, and AF is the annualization factor.

A “daily return” (Rᵢ) is the natural log of a final value (Pᵢ₊₁) of an underlying asset over an initial value (Pᵢ) of the underlying asset. The initial value (Pᵢ) and the final value (Pᵢ₊₁) of the underlying asset may be on the same trading day, consecutive trading days, or non-consecutive trading days. For example in one embodiment, the daily return may be the natural log of a closing price of an underlying asset on one day over the closing price of the underling asset on a previous trading day. In another embodiment, the daily return may be the natural log of a closing price of an underlying asset over an opening price of the underlying asset on the same trading day.

The initial value (Pᵢ) and final value (P₁₊₁) of an underlying asset may be based on a Special Opening Quotation (“SOQ”), closing price, intraday price, or any other price. Similarly, the final value (Pᵢ₊₁) of an underlying asset may be based on a SOQ, closing price, intraday price quote, or any other price.

Alternatively, realized volatility may also be calculated according to the formula:

$$Realized Volatility = \sqrt{AF} * ( {\sum }_{i = 1}^{{N}_{a}} abs ( {R}_{i} ) / {N}_{e} )$$

$$wherein \text{:}$$

$${R}_{i} = ln \frac{{P}_{i + 1}}{{P}_{i}} ,$$

Pᵢ is an initial value of the underlying asset used to calculate a daily return, Pᵢ₊₁ is a final value of the underlying asset used to calculate the daily return, Nₑ is a number of expected underlying asset values needed to calculate daily returns during the volatility calculation period, Nₐ is an actual number of underlying asset values used to calculate daily returns during the volatility calculation period, and AF is the annualization factor (for example, 252 days).

After determining a formula for calculating realized volatility at 104, specific values are defined at 106 for the variables within the formula for calculating realized volatility during the volatility calculation period. Typically, specific values will be defined for an initial value for the first daily return, a final value for the first daily return, an initial value for the last daily return, and the final value of the last daily return. In one embodiment, the initial value (Pᵢ) for a first daily return in a volatility calculation period is defined to be an initial value of the underlying asset on a first day of the volatility calculation period; a final value of the underlying asset for the first daily return is defined to be a closing price value of the underlying asset on a following trading day; an initial value for a last daily return in the volatility calculation period is defined to be a closing value of the underlying asset on a trading day immediately prior to the final settlement date; and a final value for the last daily return is defined to be a SOQ on the final settlement date. For all other daily returns, the initial and final values are defined to be the closing values of the underlying asset on consecutive trading days.

Generally, the total number of actual daily returns during the volatility calculation period is defined to be Nₐ−1, but if one or more market disruption events occurs during the volatility calculation period, the actual number of underlying asset values will be less than the expected number of underlying asset values by an amount equal to the number of market disruption events that occurred during the volatility calculation period.

A market disruption event generally occurs on a day on which trading is expected to take place to generate a value for an underlying asset, but for some reason trading is stopped or a value for the underlying asset is not available. In one embodiment, a market disruption event may be defined to be (i) an occurrence or existence, on any trading day during a one-half period that ends at the scheduled close of trading, of any suspension of, or limitation imposed on, trading on the primary trading facility or facilities of the companies comprising the underlying asset in one or more securities that comprise 20 percent or more of the level of the asset; or (ii) if on any trading day that one or more primary trading facility(s) determines to change scheduled close of trading by reducing the time for trading on such day, and either no public announcement of such reduction is made by such trading facility or the public announcement of such change is made less than one hour prior to the scheduled close of trading; or (iii) if on any trading day one or more primary trading facility(s) fails to open and if in the case of either (i) or (ii) above, such suspension, limitation, or reduction is deemed material. A scheduled close of trading is the time scheduled by each trading facility, as of the opening for trading in the underlying asset, as the closing time of the trading of such asset on the trading day. Examples of market disruption events include days on which trading is suspended due to a national day of mourning or days on which trading is suspended for national security.

If a trading facility determines that a market disruption event has occurred on a trading day, the daily return of the underlying asset on that day will typically be omitted from the series of daily returns used to calculate the realized variance over the variance calculation period. For each such market disruption event, the actual number of underlying asset values used to calculate daily returns during the settlement calculation, represented by Nₐ, will be reduced by one. Typically, if a market disruption event occurs on a final settlement date of a volatility futures contract, the final settlement date may be postponed until the next trading day on which a market disruption event does not occur. Alternatively, any other action may be taken as agreed upon by a trading facility. These actions will typically be listed in the rules and by-laws of a clearing agent.

Once the volatility calculation period begins for a volatility futures contract, the value represented by Nₑ will not change regardless of the number of market disruption events that occur during the volatility calculation period, even if the final settlement date is postponed. Typically, if the final settlement date of the expiring volatility futures contract is postponed, the length of the volatility calculation period for the next volatility futures contract is shortened by the number of market disruption events that occur at the beginning of the volatility calculation period. Likewise, the value represented by Nₑ is reduced by the number of market disruption events that occur at the beginning of the volatility calculation period.

Similarly, if a market disruption event occurs at the beginning of the volatility calculation period, the first daily return of the shortened volatility calculation period for the next volatility futures contract will be calculated using the same procedure as described. For example, if the final settlement date for the previous volatility calculation period of a volatility futures contract is postponed to a Tuesday, the initial value for the first daily return of the volatility calculation period of the next volatility futures contract would be calculated using the SOQ (or other price designated) of the underlying asset on Tuesday morning and the closing value of the asset the following Wednesday.

Once the underlying asset or assets is chosen at 102, the formula for generating the value of the statistical property reflecting the volatility of the underlying asset or assets is determined at 104, and the value of the variables within the volatility calculation period are defined at 106, the volatility futures contract based on the chosen underlying asset or assets is assigned a unique symbol at 108 and listed on a trading platform at 110. Generally, the volatility futures contract may be assigned any unique symbol that serves as a standard identifier for the type of standardized variance futures contract.

Generally, a volatility futures contract may be listed on an electronic platform, an open outcry platform, a hybrid environment that combines the electronic platform and open outcry platform, or any other type of platform known in the art. One example of a hybrid exchange environment is disclosed in U.S. patent application Ser. No. 10/423,201, filed Apr. 24, 2003, the entirety of which is herein incorporated by reference. Additionally, a trading facility such as an exchange may transmit volatility futures contract quotes of liquidity providers over dissemination networks 114 to other market participants. Liquidity providers may include Designated Primary Market Makers (“DPM”), market makers, locals, specialists, trading privilege holders, registered traders, members, or any other entity that may provide a trading facility with a quote for a volatility derivative. Dissemination Networks may include networks such as the Options Price Reporting Authority (“OPRA”), the CBOE Futures Network, an internet website or email alerts via email communication networks. Market participants may include liquidity providers, brokerage firms, individual investors, or any other entity that subscribes to a dissemination network.

As seen in FIG. 2, in one embodiment the volatility futures contracts are listed on a trading platform by displaying the volatility futures contracts on a trading facility display device coupled with the trading platform. The listing 200 displays the volatility futures contract (VT) for purchase in terms of variance points 204 or a square root of variance points 206. A variance point is a unit of realized variance over a volatility calculation period, which can be multiplied by a scaling factor such as 10,000. In FIG. 2, one volatility futures contract has a value of 625.00 in terms of variance points 208 and a value of 25.00 in terms of volatility 210. A value of 625.0 is calculated by multiplying a realized variance calculation of 0.0625 by a scaling factor of 10,000. Further, a value of 25.00 is calculated by taking the square root of 625.00 (price in terms of variance points).

In addition to listing volatility futures contracts in terms of variance points and the square root of variance points, the prices for volatility futures contracts may also be stated in terms of a decimal, fractions, or any other numerical representation of a price. Further, scaling factors for the volatility derivatives may be determined on a contract-by-contract basis. Scaling factors are typically adjusted to control the size, and therefore the price of a derivative contract.

Over the course of the volatility calculation period, in addition to listing volatility futures contracts in terms of a square root of variance points, the trading facility may also display and disseminate a cumulative realized volatility and an implied realized volatility on a daily basis, or in real-time, to facilitate trading within the volatility futures contract. Cumulative realized volatility is an average rate of the square root of the realized variance of a volatility futures contract through a specific date of the volatility calculation period. Thus, using at least one of the formulae described above, after Nₚ days in a volatility calculation period, the cumulative realized volatility may be calculated according to the formula:

$$Cumulative Volatility = \sqrt{AF * {\sum }_{i = 1}^{{N}_{P}} \frac{{R}_{i}^{2}}{{N}_{P}} .}$$

At expiration of the volatility calculation period for a volatility futures contract, the trading facility will settle a volatility futures contract at 118 such that the settlement value is equal to the cumulative realized volatility over the specified volatility calculation period. Typically, settlement of volatility futures contracts will result in the delivery of a cash settlement amount on the business day immediately following the settlement date. The cash settlement amount on the final settlement date shall be an amount based on the final settlement price of the volatility futures contract multiplied by the contract multiplier.

FIG. 3 is a block diagram of a system 300 for creating and trading derivative investment products suitable for use in creating and trading volatility futures contracts and/or volatility options contracts. In one embodiment, where the system is configured for volatility futures contracts, the system comprises a volatility property module 302, a dissemination module 304 coupled with the volatility property module 302, and a trading module 306 coupled with the dissemination module 304. Typically, each module 302, 304, 306 is also coupled to a communication network 308 coupled to various trading facilities 322 and liquidity providers 324.

The volatility property module 302 comprises a communications interface 310, a processor 312 coupled with the communications interface 310, and a memory 314 coupled with the processor 312. Logic stored in the memory 314 is executed by the processor 312 such that that the volatility property module 302 may receive current values for an underlying asset of a volatility futures contract through the communications interface 310; calculate realized volatility, cumulative realized volatility, and implied realized volatility, as described above, for the underlying asset; and pass the calculated values to the dissemination module 304.

The dissemination module 304 comprises a communications interface 316, a processor 318 coupled with the communications interface 316, and a memory 320 coupled with the processor 318. Logic stored in the memory 320 is executed by the processor 318 such that the dissemination module 304 may receive the calculated values from the volatility property module 302 through the communications interface 316, and disseminate the calculated values over the communications network 308 to various market participants 322, as described above.

The trading module 306 comprises a communications interface 326, a processor 328 coupled with the communications interface 326, and a memory 330 coupled with the processor 328. Logic stored in the memory 330 is executed by the processor 328 such that the trading module 306 may receive buy or sell orders over the communications network 308, as described above, and pass the results of the buy or sell order to the dissemination module 304 to be disseminated over the communications network 308 to the market participants 322.

FIGS. 4A and 4B show a table showing example values for a derivative investment instrument based on a volatility of an underlying asset. In one embodiment, the values may relate to a volatility futures contract over a volatility calculation period. The first column 402 represents the number of days that have passed in the volatility calculation period; column 404 shows the daily closing price of the underlying asset; column 406 shows the natural log of the current closing price of the underlying asset over the previous closing price of the underlying asset; column 408 shows the square of the value of column 406; column 410 shows the summation of the values in column 408; column 412 shows the cumulative realized volatility on each day; column 414 shows the closing price of the volatility futures contract for each day; and column 416 shows the calculated implied realized volatility for each day.

As shown in column 402, a volatility futures contract with a 90-day volatility calculation period typically includes 64 trading days. In the example, on the first trading day 418, the underlying asset closes at a value of 1122.20 (420). To calculate the realized volatility for day 1, the natural log is taken of the closing value 420 of the underlying asset on day 1 (1122.20) over the closing value 422 of the underlying asset on the previous trading day (1127.02), resulting in a value of −0.0042859 (424). The value of the natural log is squared, resulting in the value of 1.83693*10⁻⁵ (426). The value of the square of the natural log of the current day's closing price over the previous day's closing price is then summed with any previous values in column 408. Due to the fact there are no previous values on the first day, the summation is equal to 1.83693*10⁻⁵ (428). The value of the summation is then divided by the number of trading days in the volatility calculation period that has passed (1) to obtain an average volatility over the volatility calculation period, multiplied by an annualization factor to represent the number of trading days in a year (252) and multiplied by a scaling factor (10,000), resulting in a value of 46.29 (430).

In addition to volatility futures contracts, volatility derivatives also encompass volatility option contracts. A volatility option contract is a type of option product that has a strike price set at a cumulative realized volatility level for an underlying asset. The strike price to be listed may be any volatility level chosen by the trading facility.

As with traditional option contracts, a volatility option contract may include both call volatility options and put volatility options. Typically, the holder of a volatility call option receives the right to purchase a cash amount equal to the difference between the current value of the statistical property reflecting the volatility of the underlying asset and the strike price multiplied by the multiplier. Similarly, the holder of a volatility put option receives the right to sell a cash amount equal to the difference between the current value of the statistical property reflecting the volatility of the underlying asset and the strike price multiplied by the multiplier.

Due to the fact the volatility option contract is based on a statistical property, in kind settlement is not desired and cash settlement is employed. Typically, the cash settlement will be equal to the value of the statistical property reflecting volatility of the underlying asset multiplied by a predefined multiplier. Any predefined multiplier may be chosen by the trading facility.

Referring again to FIG. 1, to create and trade a volatility option contract an underlying asset is first chosen 102. As with the volatility futures contract, the underlying asset may be selected based on trading volume of a prospective underlying asset, a general interest in a prospective underlying asset among market participants, or for any other reason desired by a trading facility. The underlying asset for the volatility option contract may be equity indexes or securities; equity fixed income indexes or securities; foreign currency exchange rates; interest rates; commodity indexes; commodity or structured products traded on a trading facility or in the over-the-counter (“OTC”) market; or any other type of underlying asset known in the art.

Once the underlying asset or assets have been selected at 102, a formula is developed at 104 for generating a value of a statistical property reflecting the realized volatility of the underlying asset or assets over the defined variance calculation period. Typically, the formula to generate a value of a statistical property reflecting realized volatility for a volatility option contract is the same formula used to generate a value of a statistical property reflecting realized volatility for the volatility futures contract. Specifically, volatility for a volatility option contract may be calculated according to the formula:

$$Realized Volatility = \sqrt{AF * {\sum }_{i = 1}^{{N}_{a} - 1} \frac{{R}_{i}^{2}}{{N}_{e} - 1}} , \\ wherein \text{:}$$

$${R}_{i} = ln \frac{{P}_{i + 1}}{{P}_{i}} ,$$

Pᵢ is an initial value of the underlying asset used to calculate a daily return, Pᵢ₊₁ is a final value of the underlying asset used to calculate the daily return, Nₑ is a number of expected underlying asset values needed to calculate daily returns during the volatility calculation period, Nₐ is an actual number of underlying asset values used to calculate daily returns during the volatility calculation period, and AF is the annualization factor.

Alternatively, realized volatility may also be calculated according to the formula:

$$Realized Volatility = \sqrt{AF} * ( {\sum }_{i = 1}^{{N}_{a}} abs ( {R}_{i} ) / {N}_{e} )$$

$$wherein \text{:}$$

$${R}_{i} = ln \frac{{P}_{i + 1}}{{P}_{i}} ,$$

Pᵢ is an initial value of the underlying asset used to calculate a daily return, Pᵢ₊₁ is a final value of the underlying asset used to calculate the daily return, Nₑ is a number of expected underlying asset values needed to calculate daily returns during the volatility calculation period, Nₐ is an actual number of underlying asset values used to calculate daily returns during the volatility calculation period, and AF is the annualization factor (for example, 252 days).

As with the volatility futures contracts, specific values are defined at 106 for the variables within the formula for calculating realized volatility during the volatility calculation period. The volatility option contract is then assigned a unique symbol at 108 and listed on a trading platform at 110. The volatility option contract may be assigned any unique symbol that serves as a standard identifier for the type of standardized volatility options contract.

A volatility option contract may be listed on an electronic platform, an open outcry platform, a hybrid environment that combines the electronic platform and open outcry platform, or any other type of platform known in the art. Additionally, a trading facility may disseminate quotes for volatility option contracts over dissemination networks' 114 such as the OPRA, the CBOE Network, an internet website or email alerts via email communication networks to market participants.

As seen in FIG. 2, in one embodiment, similar to volatility futures contracts, volatility option contracts (VO) are listed 200 on a trading platform for purchase with a strike price in terms of variance points 204 or a square root of variance points 206. In FIG. 2, one volatility option contract has a value of 625.00 in terms of variance points 212 and a value of 25.00 in terms of volatility 214. As noted above with reference to the volatility futures contract discussion, a variancepoint is an expected realized variance over a volatility calculation period multiplied by a scaling factor such as 10,000.

Referring again to FIG. 1, after a volatility option contract is listed on a trading facility, an investor may trade into or out of the option contract at 116 as is well known in the art, until the option contract expires at 118.

The system 300 for creating and trading derivative investment instruments of FIG. 3 may be adapted to create and trade volatility option contracts. When configured for volatility option contracts, the system comprises a volatility property module 302, a dissemination module 304 coupled with the volatility property module 302, and a trading module 306 coupled with the dissemination module 304. Typically, each module 302, 306, 308 is also coupled to a communication network 708 coupled to various market participants 322.

The volatility property module 302 comprises a communications interface 310, a processor 312 coupled with the communications interface 310, and a memory 314 coupled with the processor 312. Logic stored in the memory 314 is executed by the processor 312 such that that the volatility property module 302 may receive current values for an underlying asset of a volatility option contract through the communications interface 310; calculate realized volatility, as described above, for the underlying asset; and pass the calculated realized volatility to the dissemination module 304.

The dissemination module 304 comprises a communications interface 316, a processor 318 coupled with the communications interface 316, and a memory 320 coupled with the processor 318. Logic stored in the memory 320 is executed by the processor 318 such that the dissemination module 304 may receive the calculated realized volatility from the volatility property module 302 through the communications interface 316, and disseminate the calculated realized volatility over the communications network 308 to various market participants 322, as described above.

The trading module 306 comprises a communications interface 326, a processor 328 coupled with the communications interface 326, and a memory 330 coupled with the processor 328. Logic stored in the memory 330 is executed by the processor 328 such that the trading module 306 may receive buy or sell orders over the communications network 308, as described above, and pass the results of the buy or sell order to the dissemination module 304 to be disseminated over the communications network 308 to the market participants 322.

FIGS. 4A and 4B, in addition to showing example values for a volatility futures contract are also applicable for showing an example of values for a volatility option contract over a volatility calculation period. In one example, a volatility call option contract may have a strike price of 135.00 and be exercised at any time during the 90-day calculation period, again assuming 64 trading days during the 90-day period. Therefore, a holder of the volatility call option contract could only exercise their option to make a profit during the 90-day volatility calculation period when the cumulative realized volatility is calculated to be above 135.00 such as on days 3-5 (454, 456, 458), 10 (460), 11 462), 14 (464), 15 (466), 28 (468), 29 (470), 34-37 (472, 474, 476, 478), and 40 (480). On all other trading days of the volatility calculation period, if the holder of the volatility call option exercised their option it would result in a loss.

Similarly, in another example, a volatility call option contract may have a strike price of 115.00 and only be exercised at the end of the 90-day calculation period. Therefore, due to the fact the cumulative realized volatility is calculated to be above 115.00 at the end of the 90-day calculation period 453, the holder of the volatility call option may exercise their option for a profit. However, if the cumulative realized volatility was calculated to be at or below 115.00 at the end of the 90-day calculation period 453, the holder of the volatility option may not exercise their option for a profit.

In yet another example, a volatility put option contract may have a strike price of 117.00 and be exercised at any time during the 90-day calculation period. Therefore, a holder of the volatility put option contract could only exercise their option to make a profit during the 90-day volatility calculation period when the realized volatility is calculated to be below 117.00 such as on days 1 (430), 2 (482), 8 (484), 9 (486), 24 (488), and 26 (490). On all other trading days of the volatility calculation period, if the holder of the volatility put option exercised their option it would result in a loss.

Similarly, in another example, a volatility put option contract may have a strike price of 125.00 and only be exercised at the end of the 90-day calculation period 453. Therefore, due to the fact the cumulative realized volatility is calculated to be below 125.00 at the end of the 90-day calculation period 453, the holder of the volatility option contract may exercise their option for a profit. However, if the cumulative realized volatility was calculation to be at or above 125.00 at the end of the cumulative calculation period 453, the holder of the volatility option may not exercise their option for a profit.

According to another aspect of the present invention, chooser options may be created based on volatility options. A chooser option is an option wherein the purchaser of the option buys a call or a put option at some time in the future. The call and the put option will typically share the same expiration date and the same strike price (value), although, split chooser options may be crafted wherein the call and the put options have different expirations and/or different strikes.

Chooser options are advantageous in situations in which investors believe that the price of the underlying asset is for a significant move, but the redirection of the move is in doubt. For example, some event, such as the approval (disapproval) of a new product, a new earnings report, or the like, may be anticipated such that positive news is likely cause the share price to rise, and negative news will cause the share price to fall. The ability to choose whether an option will be a put or a call having knowledge of the outcome of such an event is a distinct advantage to an investor.

The purchase of a chooser option is akin to purchasing both a put and a call option on the same underlying asset. Typically the chooser option is priced accordingly. In the present case, purchasing a volatility chooser option amounts to buying both a put and a call option based on the variance of an underlying asset. Chooser options may be traded on an exchange just like other volatility derivative. The only accommodations necessary for adapting an exchange for trading chooser options is that a final date for making the choice between a call option and a put option must be established and maintained. Also, post trade processing on the exchange's systems must be updated to implement and track the choice of the call or a put once the choice has been made. One option for processing the chosen leg of a chooser option is to convert the chooser option into a standard option contract according to the standard series for the same underlying asset and having the same strike price as the chosen leg of the chooser option.

It is therefore intended that the foregoing detailed description be regarded as illustrative rather than limiting, and that it be understood that it is the following claims, including all equivalents, that are intended to define the spirit and scope of this invention.

1. A method of creating derivatives based on a volatility of an underlying asset, comprising:
calculating a value for a statistical property reflecting the volatility of the underlying asset on a processor of a volatility property module, the value for the statistical property reflecting an average volatility of price returns of the underlying asset over a predefined time period;
creating at least one volatility derivative based on the statistical Property;
displaying the at least one volatility derivative on a trading facility display device coupled to a trading platform;
transmitting at least one volatility derivative quote of a liquidity provider from a dissemination module of the trading facility to at least one market participant, and
settling a volatility derivative based on a difference between a first statistical Property reflecting a volatility of the underlying asset and a strike price of the volatility derivative set at a second statistical Property reflecting a volatility of the underlying asset.

2. The method of claim 1, wherein calculating the value for the statistical property reflecting the volatility of the underlying asset comprises:
calculating the value of the statistical property according to the formula:
$$Volatility = \sqrt{AF * {\sum }_{i = 1}^{{N}_{a} - 1} \frac{{R}_{i}^{2}}{{N}_{e} - 1}} , \\ wherein \text{:}$$
$${R}_{i} = ln \frac{{P}_{i + 1}}{{P}_{i}} ,$$
Pᵢ is an initial value of the underlying asset used to calculate a daily return, Pᵢ₊₁ is a final value of the underlying asset used to calculate the daily return, Nₑ is a number of expected underlying asset values needed to calculate daily returns during a volatility calculation period, Nₐ is an actual number of underlying asset values used to calculate daily returns during the volatility calculation period; and AF is an annualization factor.

3. The method of claim 1, wherein calculating the value for the statistical property reflecting the volatility of the underlying asset comprises:
calculating the value of the statistical property according to the formula:
$$Volatility = \sqrt{AF} * ( {\sum }_{i = 1}^{{N}_{a}} abs ( {R}_{i} ) / {N}_{e} )$$
$$wherein \text{:}$$
$${R}_{i} = ln \frac{{P}_{i + 1}}{{P}_{i}} ,$$
Pᵢ is an initial value of the underlying asset used to calculate a daily return, Pᵢ₊₁ is a final value of the underlying asset used to calculate the daily return, Nₑ is a number of expected underlying asset values needed to calculate daily returns during the volatility calculation period, Nₐ is an actual number of underlying asset values used to calculate daily returns during the volatility calculation period, and AF is the annualization factor.

4. The method of claim 1, wherein calculating the value for the statistical property reflecting the volatility of the underlying asset comprises:
calculating an average of a summation of each squared daily return of the underlying asset.

5. The method of claim 4, wherein calculating the value of the statistical property reflecting the volatility of the underlying asset comprises:
removing the squared deviation of a daily return of the underlying asset that corresponds to a market disruption event.

6. The method of claim 1, further comprising:
executing trades for the volatility derivative by matching bids and offers to buy and sell positions in volatility derivatives.

7. The method of claim 1, wherein the underlying asset is selected from the group consisting of: equity indexes or securities; fixed income indexes or securities; foreign currency exchange rates; interest rates; commodity indexes; options; futures; and commodity or structured products traded on a trading facility or over-the-counter market.

8. The method of claim 1, wherein at least one of the at least one volatility derivative is a volatility option contract.

9. The method of claim 1, wherein at least one of the at least one volatility derivative is a volatility futures contract.

10. The method of claim 9, further comprising:
calculating a cumulative realized volatility of the volatility futures contract on a processor, wherein the cumulative realized volatility is an average of the value of the statistical property during a volatility calculation period of the volatility futures contract up to a current date;
displaying the cumulative realized volatility on the trading facility display device; and
transmitting the cumulative realized volatility from the trading facility to at least one market participant.

11. The method of claim 10, further comprising:
calculating an implied realized volatility of the volatility futures contract according to the formula:
$$Implied Volatility = \frac{TP - RV * \frac{{Day}_{Current}}{{Day}_{Total}}}{{Day}_{Left} / {Day}_{Total}} ,$$
wherein TP is a last trading price of the volatility futures contract; RV is the cumulative realized volatility; Day_{current} is a total number of trading days that have passed in the volatility calculation period; Day_{Total} is a total number of trading days in the volatility calculation period; and Day_{Left} is a number of trading days left in the volatility calculation period;
displaying the implied realized volatility on the trading facility display device; and
transmitting the implied realized volatility from the trading facility to at least one market participant.

12. The method of claim 9, wherein the volatility futures contract has a set expiration date.

13. The method of claim 1, wherein the trading platform is an open outcry platform.

14. The method of claim 1, wherein the trading platform is an electronic platform.

15. The method of claim 1, wherein the trading platform is a hybrid of an open outcry platform and an electronic platform.

16. The method of claim 1, further comprising:
transmitting the at least one volatility derivative quote from the trading facility over at least one dissemination network.

17. The method of claim 16, wherein the dissemination network is the Options Price Reporting Authority.

18. The method of claim 1, wherein the trading facility is an exchange.

19. The method of claim 1, wherein the liquidity provider is selected from the group consisting of: Designated Primary Market Makers (“DPM”), market makers, locals, specialists, trading privilege holders, members, and a registered trader.

20. The method of claim 1, wherein the market participant is selected from the group consisting of: a liquidity provider, a brokerage firm, and a normal investor.

21. A computer-readable storage medium comprising a set of instruction for creating derivatives based on a volatility of an underlying asset, the set of instructions to direct a processor to perform acts of:
calculating a value for a statistical property reflecting the volatility of the underlying asset, the value for the statistical property reflecting an average volatility of price returns of the underlying asset over a predefined time period;
creating at least one volatility derivative based the statistical property;
displaying the at least one volatility derivative on a trading facility display device coupled to a trading platform;
transmitting at least one volatility derivative quote of a liquidity provider from a dissemination module of the trading facility to at least one market participant; and
settling a volatility derivative based on a difference between a first statistical property reflecting a volatility of the underlying asset and a strike price of the volatility derivative set at a second statistical property reflecting a volatility of the underlying asset.

22. A system for creating and trading derivatives based on the volatility of an underlying asset, comprising:
a volatility property module comprising a first processor, a first memory coupled with the first processor, and a first communications interface coupled with a communications network, the first processor, and the first memory;
a dissemination module coupled with the volatility property module, the dissemination module comprising a second processor, a second memory coupled with the second processor, and a second communications interface coupled with the communications network, the second processor, and the second memory;
a trading module coupled with the dissemination module, the trading module comprising a third processor, a third memory coupled with the third processor, and a third communications interface coupled with the communications network, the third processor, and the third memory;
a first set of logic, stored in the first memory and executable by the first processor to receive current values for an underlying asset of a volatility derivative through the first communications interface; calculate a realized volatility, cumulative realized volatility, and implied realized volatility for the underlying asset; and pass values for the calculated realized volatility, cumulative realized volatility, and implied realized volatility to the dissemination module; and
a second set of logic, stored in the second memory and executable by the second processor to receive the calculated realized volatility, cumulative realized volatility, and implied realized volatility values for the underlying asset from the volatility property module; and disseminate the calculated values through the second communications interface to at least one market participant; and
a third set of logic, stored in the third memory and executable by the third processor, to receive at least one buy or sell order over the communications network; execute the buy or sell order; pass a result of the buy or sell order to the dissemination module; and settle at least one trading derivative based on a difference between a first statistical property reflecting a volatility of the underlying asset and a strike price of the at least one trading derivative set at a second statistical property reflecting a volatility of the underlying asset.

23. A method of creating derivatives based on a volatility of an instrument based on an underlying asset, comprising:
calculating a value for a statistical property reflecting the volatility of the instrument based on the underlying asset on a processor of a volatility property module, the value for the statistical property reflecting an average volatility of price returns of the instrument based on the underlying asset over a predefined time period;
creating at least one volatility derivative based on the statistical property;
displaying the at least one volatility derivative on a trading facility display device coupled to a trading platform;
transmitting at least one volatility derivative quote of a liquidity provider from a dissemination module of the trading facility to at least one market participant; and
settling a volatility derivative based on a difference between a first statistical property reflecting a volatility of the instrument based on the underling asset and a strike price of the volatility derivative set at a second statistical property reflecting a volatility of the instrument based on the underlying asset.

24. A computer-readable storage medium comprising a set of instructions for creating derivatives based on a volatility of an instrument based on an underlying asset, the set of instructions to direct a processor to perform acts of:
calculating a value for a statistical property reflecting the volatility of the instrument based on the underlying asset, the value for the statistical property reflecting an average volatility of price returns of the instrument based on the underlying asset over a predefined time period;
creating at least one volatility derivative based on the statistical property;
displaying the at least one volatility derivative on a trading facility display device coupled to a trading platform;
transmitting at least one volatility derivative quote of a liquidity provider from a dissemination module of the trading facility to at least one market participant; and
settling a volatility derivative based on a difference between a first statistical property reflecting a volatility of the instrument based on the underling asset and a strike price of the volatility derivative set at a second statistical property reflecting a volatility of the instrument based on the underlying asset.
